(19) United States
(12) Patent Application Publication
(10) Pub. No.: US 2014/0168409 A1
(43) Pub. Date: Jun. 19, 2014

(54) CONSTRUCTION IMAGE DATA RECORDING SYSTEM AND DATA RECORDING UNIT ADAPTED TO BE EMBEDDED IN A STRUCTURE

(71) Applicant: MITOMO CORPORATION, Kanagawa (JP)

(72) Inventor: Kikuo Kaga, Tokyo (JP)

(73) Assignee: MITOMO CORPORATION, Kanagawa (JP)

(21) Appl. No.: 14/001,514

(22) PCT Filed: Mar. 5, 2013
(86) PCT No.: PCT/JP2013/055944

§ 371 Date: Aug. 26, 2013

(30) Foreign Application Priority Data
Dec. 18, 2012 (JP) 2012-275630

(51) Int. Cl. G06T 7/00

(52) U.S. Cl. CPC G06T 7/0004
USPC 348/86

(57) ABSTRACT

A construction image data recording system and a construction image data recording unit, those which make possible to input image data with a capacity even exceeding the storing capacity of an IC tag, such as photographic data, to the IC tag at either the construction site or the verification site of a concrete structure and to directly read such data from the IC tag at the construction site are provided.

The construction image data recording system according to the present invention comprises an IC tag 2, 21 adapted to be embedded in a concrete structure and to record construction image data, a reader-writer 3 for writing the construction image data to and reading said data from the IC tag, a data processing unit 10 for optimizing the capacity of the construction image data to be written to the IC tag and restoring the construction image data read by the reader-writer, a display unit 8 for displaying the construction image data, and a photographing unit 5 for inputting the image data to said data processing unit.

### FIELD OF INVENTION

The present invention relates to a construction image data recording system to be used for the quality control of a cement product and a structure made of concrete, mortar and so on and to a data recording unit adapted to be embedded in a structure.

### BACKGROUND ART

For instance, for mortar and cement products and a structure made of concrete in the field of civil engineering, information on the strength of a structure and the records of construction must be verified when the checking and repairing of the structure is conducted after a lapse of several years, or when disaster such as earthquake has happened. Such information is normally recorded in the form of papers and maintained together with the drawings used at the time of the construction. In general, the contractor of the structure records construction process of works on a prescribed ledger for every construction to prepare a construction report. Normally, a photograph specifying the details of the construction site is attached to the construction report. When taking such photograph as data, a board on which the title of the construction, the date, the location, the construction method adopted and so on are written is stood in the site to be photographed. Then, this photograph and the prescribed matters are composed so that the construction report is prepared. However, such a manner of handling the construction report may cause troubles of missing the documents and/or falsification of the information. Furthermore, there could be such a possibility that the photograph of the construction may not be coincident with the construction data on the object of the construction.

In association with recent advanced information technology, a construction photograph management system and a construction photograph management method, with which image data containing tag data being consisted of one dimensional data and two dimensional data are prepared basing on data on the date, data on the photographing site, data on the construction type and so on and stored, and the stored tag data are then extracted and decoded to obtain the construction information, such as data on the date, data on the photographing site and so on (Patent Document 1).

Besides, a quality management system wherein an IC tag capable of writing and reading information on construction is put into fresh concrete prior to casting of said fresh concrete, and after the casting, information on the construction are written to and read from said IC tag (Patent Documents 5 and 6). Furthermore, a construction state recording method and an apparatus thereof, and position information registering unit, with those which the position information obtained from an IC tag is associated with the photograph data to thereby cause the memory to store the position information in association with the photograph data so that the photograph data can be managed in an associated state with the construction site (Patent Document 2).

Further, a digital camera dedicated for construction photographs which causes the camera to move at the time of photographing in the next construction work so that present photographing position data obtained by means of a GPS system comes to be coincident with the photographing position data recorded in the memory card is disclosed (Patent Document 3). Still further, a quality confirmation system to be used in a construction site, which is configured so as to accomplish checking of the construction materials by checking up information on the specification of a material stored in an IC tag with information on the specification of said material stored in a PC, is disclosed (Patent Document 4).

The foresaid method which uses an IC tag to write and read information on construction has an advantage of allowing to obtain the information on construction owing to the data transmission/reception function of the IC tag even though missing of the documents and drawings due to aging happens. However, it is difficult for this sort of IC tag to store data with a great capacity, such as photograph data, and therefore, it is required to store photograph data in a separate memory. In that case, when the construction report is prepared, only ID information data with a small capacity is stored in the IC tag and the ID information is read with a reader-writer. On the other hand, the image data of the photographed construction site taken by a photographing apparatus is stored in a memory such as data server and displayed on a display unit in such a form that the ID information read by the reader-writer is associated with the image data stored in the memory by means of the data processing unit.

### REFERENCE OF THE PRIOR ART

### Patent Documents

[Patent Document 1]: Japanese Unexamined Patent Application Publication No. 2010-165263
[Patent Document 2]: Japanese Unexamined Patent Application Publication No. 2009-275406
[Patent Document 3]: Japanese Unexamined Patent Application Publication No. 2009-253659
[Patent Document 4]: Japanese Unexamined Patent Application Publication No. 2005-327170
[Patent Document 5]: Japanese Unexamined Patent Application Publication No. 2008-63900
[Patent Document 6]: Japanese Unexamined Patent Application Publication No. 2009-282688

### DESCRIPTION OF THE REFERENCE NUMERALS

1: Building
2: IC tag
3: Reader-writer
31: Radio communication section
4: Non-volatile memory
5: Photographing unit
51: Lens
6: Memory
7, 10: Data storing unit
8: Display unit
11, 12: Data optimizing means
20, 26: Data recording unit adapted to be embedded in a structure
21: IC tag
22: Concrete block
23: Resin-made shell
24: IC tag main body

### SUMMARY OF THE INVENTION

There is such a problem in both of the foresaid construction photograph management apparatus and the management method thereof disclosed in Patent Document 1 that, although burdensome chores, such as manual arrangement of information on the construction and preparation of the report, can be reduced, since photographed data are sent to a memory such as a data server being remote from the construction site and are stored therein, there could be an event that the photographed data have been already deleted when anyone desires to look said photographed data. Yet, when anyone desires to check the construction data (particularly photographic data with a great capacity) at the construction site, it is required to access to the memory, and if the construction site is located in the area out of the communication-available range, for example the construction is implemented at a place back in the mountains where communication condition is poor, a problem that no photographic data can be downloaded from the data server may happen. In addition, there is fear that the photographic data in the memory could be falsified.

It is an object of the present invention to provide a construction image data recording system, which can input even construction data (particularly photographic data) with a great capacity exceeding the capacity of a non-volatile memory provided to an IC tag at either the construction site or the verification site of a building and can directly read such data from the IC tag at the construction site.

It is another object of the present invention to provide a data recording unit adapted to be embedded in a structure, with which an IC tag can be efficiently disposed inside the verified part of a building or the like, and which can ensure the directionality of the IC tag at the time of inputting and/or outputting data to firmly write data to and read data from the IC tag.

According to the present invention, a construction image data recording system comprising an IC tag adapted to be embedded in a structure and to record construction image data, a reader-writer for writing the construction image data to and reading said data from said IC tag, a data processing unit for optimizing the capacity of said construction image data to be written to said IC tag and for restoring construction image data having been read by the reader-writer, a display unit for displaying said construction image data and a photographing unit for inputting image data to said data processing unit is provided.

According to one embodiment of the present invention, the construction image data recording system is characterized in that said data processing unit includes a data optimizing means for performing data compression so that the capacity of data can be reduced so as to be acceptable to the capacity of a non-volatile memory provided to the IC tag, the compressed image data by said data capacity optimizing means is written from said reader-writer to said IC tag, and the read compressed data read from said IC tag by said reader-writer is decompressed by said data optimizing means to display the decompressed data on said display unit.

Besides, according to another embodiment of the present invention, the construction image data recording system is characterized in that said data processing unit includes a data optimizing means for dividing data to a plurality of data so that the divided data can be stored within the capacity of a non-volatile memory provided to said IC tag, the divided image data by said data optimizing means are written to a plurality of said IC tags together with the associated connecting information, and a plurality of said divided data read from said plurality of IC tags by said reader-writer are reintegrated by said data optimizing means to the original image data based on the associated connecting information to thereby display the reintegrated data on said display unit.

Further, according to still another embodiment of the present invention, said data processing unit includes a data optimizing means for performing data compression so that the capacity of data can be reduced so as to be acceptable to a capacity of a non-volatile memory provided to the IC tag and dividing the data into a plurality of data, the compressed and divided image data by said data optimizing means is written to said plurality of IC tags together with the associated connecting information, and said plurality of compressed and divided data having been read from said plurality of IC tags by said reader-writer is decompressed by said data optimizing means to the original image data based on the associated connecting information to thereby display the decompressed data on said display unit.

The data recording unit adapted to be embedded in a structure according to the present invention is characterized in that an IC tag is embedded in a concrete block and said concrete block is embedded in a desired location in the structure.

Further, according to still another embodiment of the present invention, the construction image data recording system is characterized in that said IC tag is embedded inside the concrete block wherein the position and the direction of the IC tag relative to the concrete block are defined so that the direction of the data input side of the IC tag can be recognized from the outer surface of the concrete block.

Furthermore, according to still another embodiment of the present invention, the construction image data recording system is characterized in that a plurality of IC tags are embedded inside the concrete block in the same direction at intervals with which no interference to writing and reading data is caused between the IC tags.

According to still another embodiment of the present invention, the construction image data recording system is characterized in that said compressed image data is written to said IC tag.

According to still another embodiment of the present invention, the construction image data recording system is characterized in that said divided image data are written to said plurality of IC tags together with the associated connecting information.

According to still another embodiment of the present invention, the construction image data recording system is characterized in that said compressed and divided image data are written to said plurality of IC tags together with the associated connecting information.

According to still another embodiment of the present invention, the construction image data recording system is characterized in that said structure is a structure made of concrete.

The construction image data recording system according to the present invention can input even photographic data with a great capacity to an IC tag at the construction site and read the data from the IC tag at the construction site to restore the data to the original photograph and display the restored photograph.

Furthermore, according to the construction image data recording system of the present invention, it is not required to introduce a number of IC tags at random to a kneaded material such as fresh concrete, and those IC tags can be embedded to targeted locations to be verified and the uniform directionality of those IC tags can be ensured.

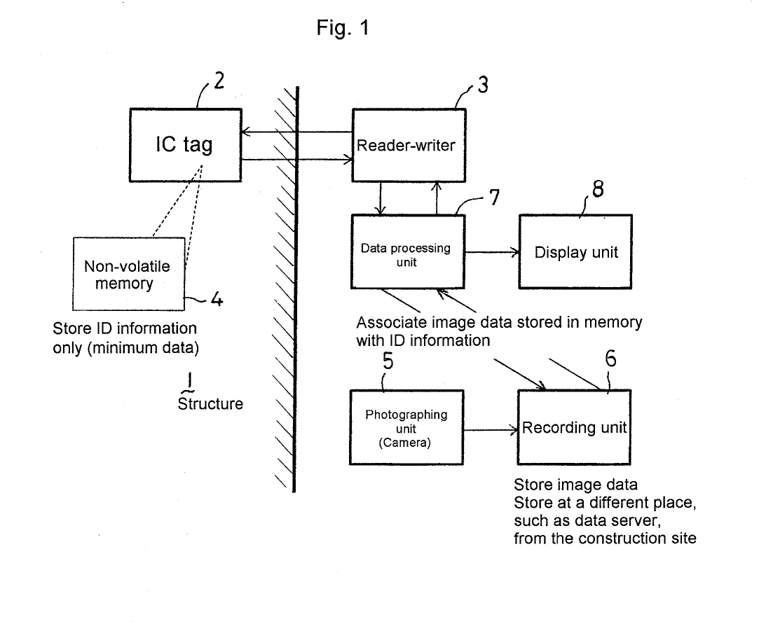

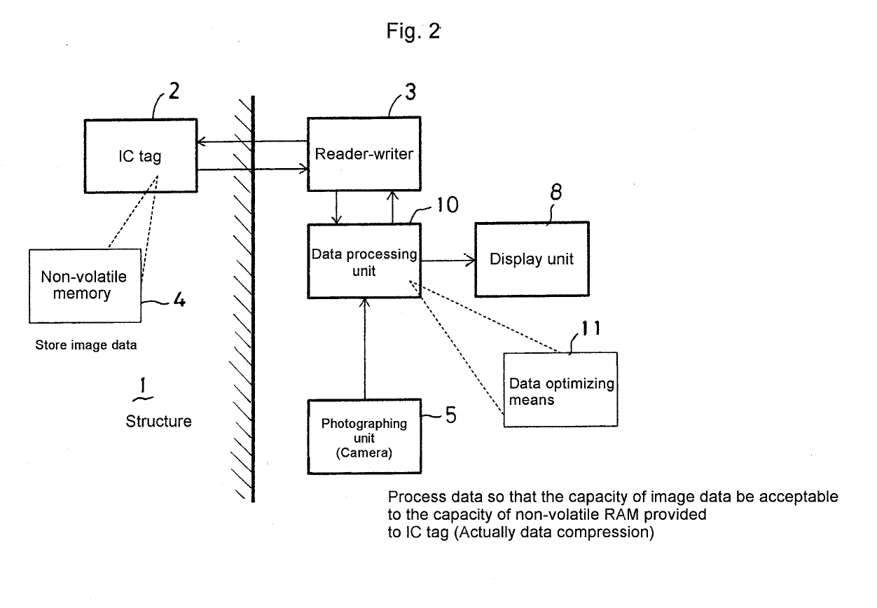

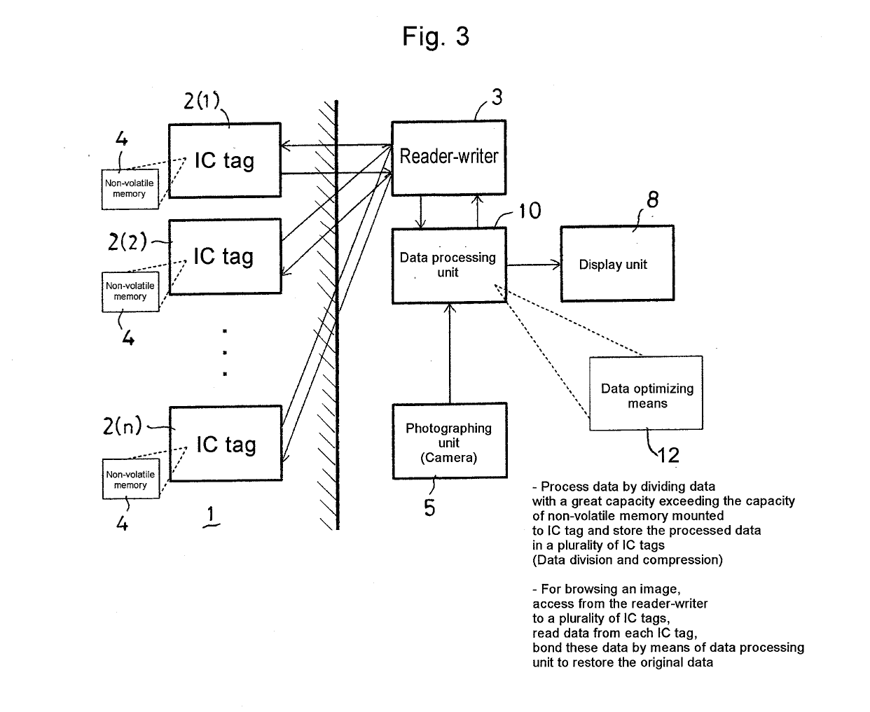

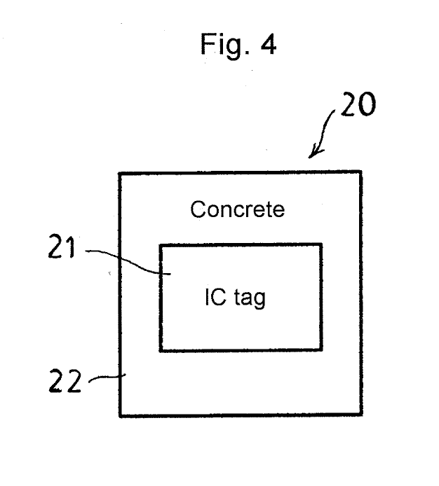

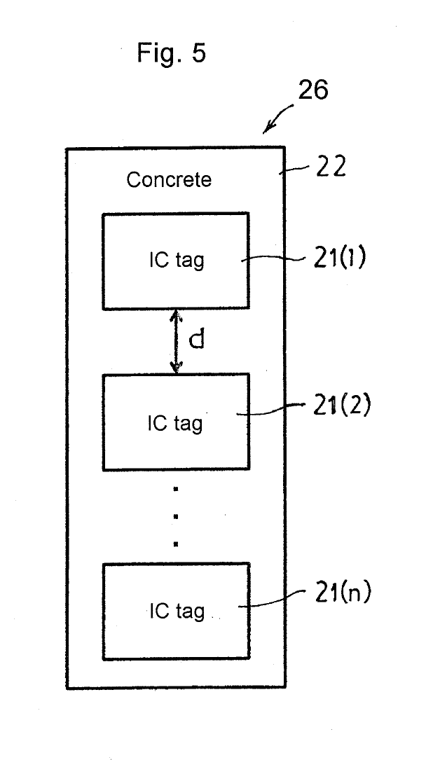

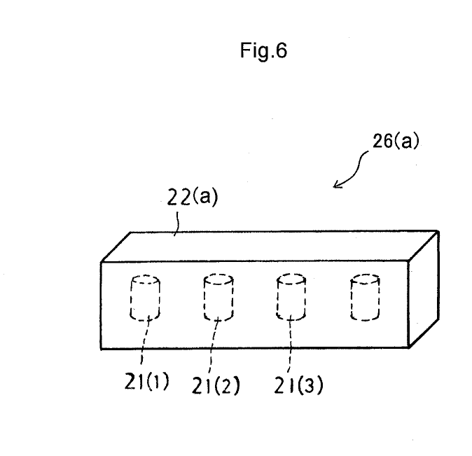

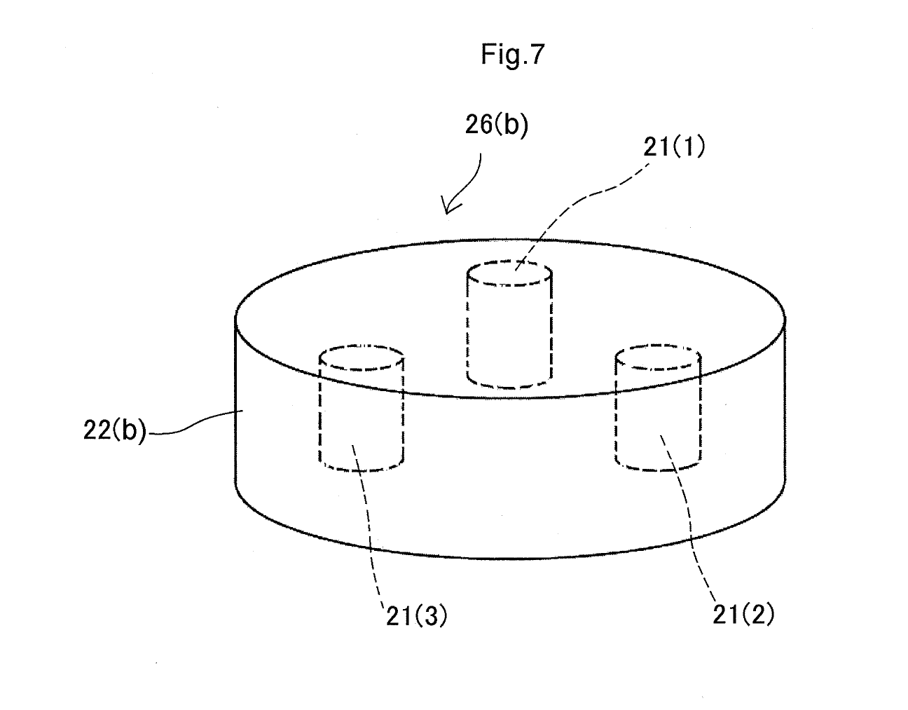

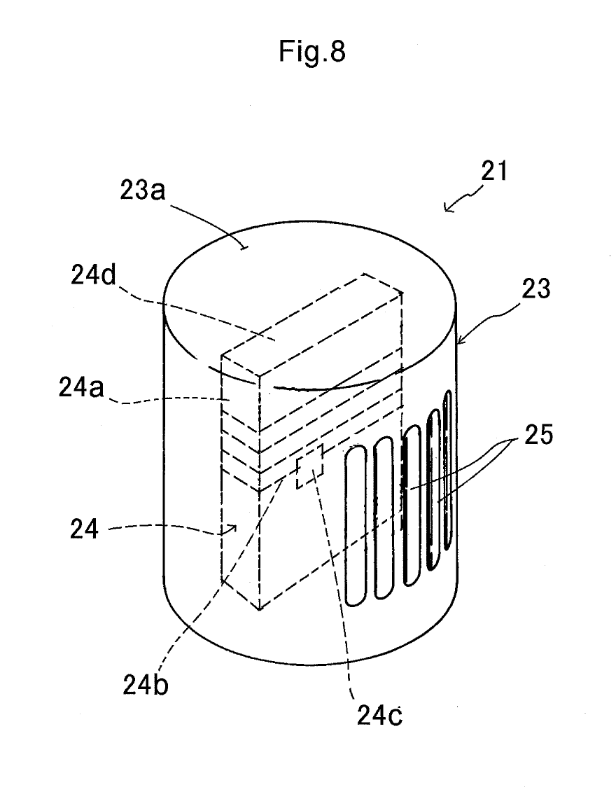

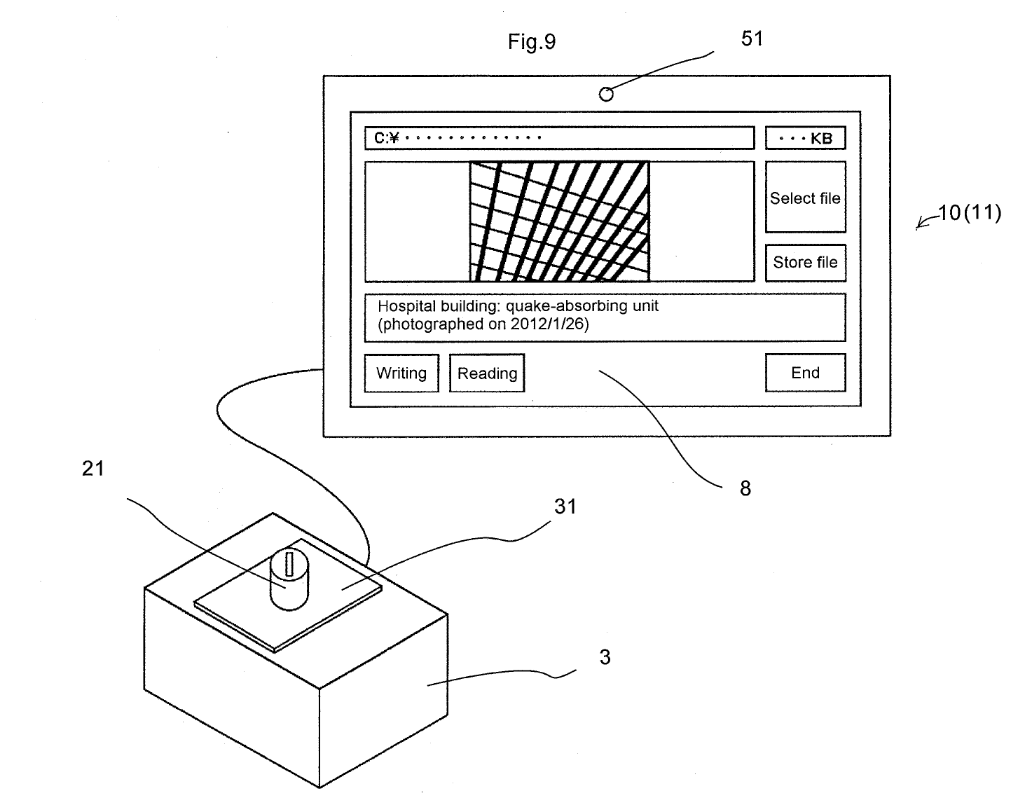

### BRIEF DESCRIPTION OF THE DRAWINGS

[FIG. 1] A block diagram illustrating an example of the conventional construction image data recording system using the IC tag.

[FIG. 2] A block diagram illustrating the construction image data recording system of Example 1 according to the present invention.

[FIG. 3] A block diagram illustrating the construction image data recording system of Example 2 according to the present invention.

[FIG. 4] A front view of the data recording unit adapted to be embedded in a structure according to Example 3 of the present invention.

[FIG. 5] A front view of the data recording unit adapted to be embedded in a structure according to Example 4 of the present invention.

[FIG. 6] A schematic perspective view illustrating the use example of the data recording unit adapted to be embedded in a structure according to Example 5 of the present invention.

[FIG. 7] A schematic perspective view illustrating the use example of the data recording unit adapted to be embedded in a structure according to Example 5 of the present invention.

[FIG. 8] A schematic perspective view of an example of the IC tag which is applied to each of Examples of the present invention.

[FIG. 9] A schematic perspective view of the reader-writer and the data processing unit, with those which the construction image data recording system according to each of Examples of the present invention can be achieved.

### DETAILED DESCRIPTION OF THE PREFERRED EMBODIMENTS

Now, the present invention will be explained specifically by means of various Examples described below with reference to the appended drawings. Note that the system according to the present invention is applied to a building made of concrete in all of Examples described below. However, the system according to the present invention can be applied for the internal verification and quality management of not only such structures but also of all types of structures made of concrete and mortar, such as bridges and tunnels.

Before commencing explanation on Examples according to the present invention, the construction image data recording system of the conventional type using an IC tag 2 indicated FIG. 1 will now be explained. In the conventional system, in order to store image data such as photographic information and the like with a great data capacity, only ID information for associating IC tag 2 with image data is stored in the IC tag 2, while the image data is stored in the state associated with the ID information in a memory 6 with a great storing capacity, such as a server, which locates at a place different from the construction site. On the other hand, when image data such as photographic information is displayed on a display unit 8, the data processing unit 7 accesses to the memory 6 and associates the ID information read from the IC tag 2 by the reader-writer 3 with the image data stored in the memory 6 to display the image data corresponding to the IC tag 2 on the display unit. According to this method, however, since the photographic information is stored in the memory 6 which is remote from the construction site, it is required to access to the memory 6 every time in order to see the information. Furthermore, due to missing or falsification of the stored information, or due to the communication circumstances, such access to the memory 6 could be knocked out.

### EXAMPLES

### Example 1

Now, the examples of the present invention will be explained. With referring to FIG. 2 illustrating Example 1, the construction image data recording system according to Example 1 comprises an IC tag 2 to be embedded in a predetermined part of a building 1 made of concrete or the like, a reader-writer 3 for writing data to and reading data from the IC tag 2, a data processing unit 10 in which a data optimizing means 11 is established, a display unit 8 and a photographing unit 5.

The IC tag 2 is an RFID tag in which a non-volatile memory 4, a controller (not shown), an antenna (not shown), etc. have been built in. The data processing unit 10 is a computer wherein a CPU, a RAM, an inputting means, etc. are included, and a data optimizing means 11, an image data displaying means (not shown), etc. are established in said data processing unit 10. The photographing unit 5 comprises an apparatus adapted to convert a photograph to the data and input the data to the data processing unit 10, for example a digital camera. While the display unit 8 comprises an apparatus adapted to make an image data visible, for example a monitor connected to or mounted on a computer.

In Example 1, the data processing means 11 comprises a data compression program functioning to compress data and a data decompression program functioning to decompress data. In one example for the data compression program, when data with a great capacity is introduced to the data processing unit 10, the data compression program works to compress said date so that the capacity of said data is reduced to an extent that can be acceptable to either a prefixed storing capacity or the storing capacity (e.g. 8 KByte) of the non-volatile memory 4 to which said data is written. While the data decompression program, when the compressed data is inputted to the data processing unit 10, works to decompress the compressed data to get back the data with the original capacity. Note that various data compression techniques, such as run-length method, Huffman method and LZ77 method, are known as the data compression/decompression techniques, however, there is no limitation in those data compression/decompression methods to be used for the present invention.

Now, the operation of the construction image data recording system according to Example 1 will be explained. In the operation of writing image data to the IC tag 2, when construction image data of the quake-absorbing structure, reinforcing steels, etc. photographed with the photographing unit 5 are inputted to the data processing unit 10, the data optimizing means 11 of the data processing unit 10 starts an optimizing processing of data capacity to compress the capacity of the image data either down to a prefixed capacity or to data capacity being appropriate for the storing capacity of the IC tag 2. The data processing unit 10 transmits the compressed image data to the reader-writer 3, the reader-writer 3 writes the compressed image data to the IC tag 2 via radio communication, and the compressed image data is stored in the non-volatile memory 4.

Besides, in the operation of reading image data from the IC tag 2, when the reader-writer 3 being in its activated state is positioned within the communication range of the IC tag 2, the IC tag 2 is activated and the compressed image data stored in the non-volatile memory 4 is read by the reader-writer 3. When the compressed image data is inputted from the reader-writer 3 to the data processing unit 10, the data optimizing means 11 of the data processing unit 10 decompressed the compressed image data to get back the original image data. The data processing unit 10 displays the image data by means of an image data displaying means on the display unit 8.

Note that data written to the IC tag 2 is not limited to the construction image data of the construction site. For example, construction text data, such as data on the dates, the photographing sites and the construction types, may be inputted by an inputting unit or the like, which is either connected to or mounted on the data processing unit 10, and construction data in which the construction text data is associated with the construction image data may be compressed to an appropriate capacity by means of the data optimizing means 11 and is then written to the IC tag 2. Alternatively, said construction text data may be associated with the compressed image data to write those data as construction data to the IC tag 2. In particular, when a global positioning system (GPS) is mounted on either the photographing unit or the data processing unit 10, the position data determined by said positioning system may also be inputted to the data processing unit 10, and the construction data including said position data may be written to the IC tag 2.

As described above in Example 1, construction image data of which capacity exceeding the storing capacity of the IC tag 2 can be written by the reader-writer 3 to the IC tag 2 together with data relating to the other constructions, and these data can be restored by the reader-writer 3 and the data processing unit 10 to thereby display the restored data on the display unit 8 at the construction site. Accordingly, writing and reading of data with a great capacity can be easily achieved at the construction site, even though said construction is carried out in a place out of the communication-available area like a mountain area, whereby the disaccord of the objective building and the data to be verified may be prevented from occurring.

### Example 2

In Example 2 shown in FIG. 3, a plurality of IC tags 2(1), 2(2), . . . 2(n) are embedded in a building 1 made of concrete or the like. Note that, in Example 1 as well, a plurality of IC tags as a whole may be embedded in a building. As described later, each of the divided data is written to the corresponding IC tag 2(1), 2(2), . . . 2(n), respectively.

The construction image data recording system according to Example 2 comprises IC tags 2, a reader-writer 3, a data processing unit 10, a photographing unit 5, and a display unit 8 in the same manner as those in Example 1. Therefore, explanation on these components shall be omitted. The data optimizing means 12 established in the data processing unit 10 comprises a data dividing program adapted to divide data with a great capacity like a photograph to a plurality of data and a data reintegrating program adapted to reintegrate those divided data. In an example of the data dividing and reintegrating program, when data with a great capacity is inputted to the data processing unit 10, the program divides the data down to a prefixed storing capacity or to an extent being acceptable to the storing capacity (e.g. 8 KByte) of the non-volatile memory to which the data is written. Then, in the first divided data, the associated connecting information on following second divided data is embedded, and further in the second divided data, the associated connecting information on the following third data is embedded. Such embedding is repeated n times in accordance with the data capacity and the divided data capacity, and the final data is made evident by either embedding no connecting information in the n-th data or embedding information that indicates that the embedded data is the final. On the other hand, when the divided data is inputted to the data processing unit 10, the data reintegrating program associates the respective data with each other based on the connecting information embedded according to the data dividing program to thereby reintegrate the divided data to the original image data. Note that the data dividing and reintegrating method is not limited to the method as described above, and the associated connecting information of the divided data may be stored in the IC tag 2.

Now, the operation of the construction image data recording system according to Example 2 will be explained. In the operation to write image data to the IC tag 2, when the image data of the construction site taken with the photographing unit 5 is inputted to the data processing unit 10, the data optimizing means 12 of the data processing unit 10 performs the data optimizing processing, wherein the image data is divided so as to be data with a preset data capacity or data with capacity appropriate to the storing capacity of the non-volatile memory 4 in the IC tag 2, and further simultaneously performs embedding processing of the associated connecting information in the divided image data. The data processing unit 10 transmits the divided image data to the reader-writer 3, the reader-writer 3 writes the divided image data to the IC tags 2(1), 2(2), . . . 2(n) via radio communication, and said divided image data are stored in the non-volatile memory 4.

When data is read from each of the IC tags 2(1), 2(2), . . . 2(n), the reader-writer 3 accesses to a plurality of the IC tags 2(1), 2(2), . . . 2(n) and read the divided data respectively from each of the IC tags, the data optimizing means 12 of the data processing unit 10 reintegrates the divided image data based on the associated connecting information to reintegrate the divided data to the original image data. The data processing unit 10 displays the image data on the display unit 8 by means of the image data display means. Note that, similarly to Example 1, construction text data with a small capacity other than an image data may be associated with the corresponding image data and simultaneously displayed on the display unit 8.

Although the configuration with which data is divided by means of the data optimizing means 12 is explained in Example 2, however, in the modified example of Example 2, data may be simultaneously divided and compressed, and the divided and compressed data may be written to the respective IC tags together with the associated connecting information. When data is read and displayed, the respective data may be reintegrated and decompressed by means of the data optimizing means 12 of the data processing unit 10 based on the associated connecting information, and is then displayed on the display unit 8. According to this modified example, writing and reading of a high-quality image with a further greater capacity can be achieved.

Before explaining Example 3 according to the present invention, the conventional method for embedding an IC tag will now be explained. Up till now, an IC tag is dropped by means of an injector into fresh concrete having been mixed at a factory producing fresh concrete, then transferred to the construction site by means of a concrete mixer vehicle, and casted for building a concrete structure. Therefore, the IC tag is embedded at random inside the wall of the building or inside the floor, the IC tag had been searched with a searching apparatus or the like from the outside of the building, and writing data to and reading data from the IC tag was accomplished by the reader-writer.

### Example 3

FIG. 4 shows a data recording unit 20 adapted to be embedded in a structure which is intended to be used for the construction image data recording system according to Example 1 or Example 2 of the present invention. The recording unit 20 adapted to be embedded in a structure is configured in that an IC tag 21 is enclosed in a concrete block 22 and the concrete block enclosing an IC tag 21 is embedded in a concrete structure at the construction site. As shown in FIG. 8, the IC tag 21 comprises an IC tag main body 24 which is enclosed inside a cylindrical-shaped outer shell 23 made of resin which is resistant to alkalis. This IC tag main body 24 is an RFID tag in which an IC chip 24c comprising a non-volatile memory, a controller, a modem, an electric source section for receiving radio waves from the outside to resonate therewith for generating current and so on is mounted on a ferrite core 24a and an antenna coil 24b is connected to the IC chip. Around the outer circumferences of said resin-made outer shell 23, a plurality of concave 25 recesses for ensuring the adhesiveness and compatibility with the concrete block are formed. The surfaces 24d for inputting and outputting signals of the IC tag 21 sit opposite to the upper and lower end surfaces 23a, respectively. Note that the IC tag applied to the present invention is not limited to the one shown in the drawings, and IC tags with the other configurations, e.g. the configuration described in Japanese Unexamined Patent Application Publication No. 2009-282688, may be applied.

The recording unit 20 adapted to be embedded in a structure comprising a concrete block 22 in which an IC tag 21 is enclosed as described above is embedded in a desired location in a targeted concrete building. In this operation, the direction of the data inputting/outputting surface (data transmission/reception surface) of the IC tag 21 may be specifically recognized from the outer surface of the concrete block 22, whereby the concrete block can be embedded in a building properly at the time of embedding the concrete block so that right directionality of the IC tag to the reader-writer can be ensured. For example, the directionality of the IC tag is ensured by putting a mark corresponding to the data inputting/outputting surface of the IC tag to the outer surface of the concrete block or, when the concrete block is cylinder-shaped, arranging both end surfaces of the cylindrical body and the data inputting/outputting surface of the IC tag so as to face with each other.

By enclosing the IC tag in a concrete block and embedding the concrete block in an appropriate and easy location for the verification as described above, construction image data prepared by photographing the details which will be invisible from the outside after completion of construction, i.e. quake-absorbing structures, numbers of reinforcing steels in a column, the diameter of the reinforcing steel used, the distance between reinforcing steels, etc., can be obtained from the concrete block after completion of the construction, and the construction image data and the constructed structure itself can be preserved in the associated state.

### Example 4

FIG. 5 shows the data recording unit 26 adapted to be embedded in a structure which is used in the construction image data recording system according to Example 1 or Example 2 of the present invention. In the data recording unit 26 adapted to be embedded in a structure, a plurality of IC tags 21(1), 21(2), . . . 21(n) are embedded in a concrete block 22. In this respect, the distance d between those IC tags adjacent to each other is set to such a distance that an IC tag is not affected and interfered by the adjacent IC tag, and the respective IC tags 21(1), 21(2), . . . 21(n) are arranged so as to be arranged in the same direction so that no variation be caused in the directionality of all of the respective IC tags.

As the concrete block 22, the one having a shape and a size, with those which the block 22 can be easily embedded inside the targeted structure corresponding to the configuration of said structure, is selected. For example, as exemplified with the reference numeral 26(a) in FIG. 6 and the reference numerals 26(b) in FIG. 7, the shape of the concrete block 22 is preferably selected to be rectangular or cylindrical like the concrete blocks 22(a) and 22(b), because such shape is convenient to arrange the directionality of the IC tags, and the directionality of the antenna is ensured by arranging the IC tags in parallel in said concrete block.

The data recording unit 26 adapted to be embedded in a structure is particularly adapted to be used in the construction image data recording system for recording plural divided image data according to Example 2 of the present invention. In case that different data to be written may be stored in an IC tag, it is possible, for instance, to constitute the data recording unit 26 to a configuration of writing in a sorting manner the a plurality of different image data to a plurality of IC tags in the concrete block 22, 23 such that the image data taken at A location of a structure is written to the first IC tag 21(1) in the concrete block 22, the image data taken at B location is written to the IC tag 21(2) and the image data taken at C location is written to the IC tag 21(3).

Note that the block for enclosing the IC tag 21 is not limited to a concrete material, and it is possible to choose a material similar to material of the structure, as far as it does not affect the structure to be embedded, such as mortar or the like can be chosen. Further, the surface of said block may be formed so as to be rough surface in order to enhance the adhesiveness and compatibility of the block to the structure. For example, the data recording unit 20 adapted to be embedded in a structure can be embedded integrally with the structure itself by setting the data recording unit 20 adapted to be embedded in a structure which is constituted in a concrete block 22 to the basal part of the structure and then casting fresh concrete thereto.

### Example 5

FIG. 9 shows an example of the data processing unit 10, the photographing unit 5, the display unit 8 and the reader-writer 3, respectively, with those which the construction image data recording system according to Example 1 or Example 2 of the present invention is realized. The data processing unit 10 is a computer of the tablet type provided with a lens 51 functioning as a photographing unit 5, a display unit 8 functioning as a digital camera and a monitor, and a touch panel functioning as an input means, wherein a reader-writer 3 including a radio communication section 31 is connected to the data processing unit 10. To this data processing unit 10, an image data display means and a browser functioning as an inputting means for operating the reader-writer are further mounted. When the construction site is photographed by the photographing unit 5, the photographed image data is stored in a memory provided to the data processing unit 10. When clicking the file selection icon in the browser to read out said image data, said image data is associated with the image display position of the browser and displayed. Further, text data such as the inputted construction-related data are displayed at the text data display position. At the same time, the data optimizing means is activated to carry out data optimizing operations (compression and dividing processing) as shown in Example 1 or Example 2, and the reader-writer 3 writes data to the IC tag 2 locating in the communication range of said reader-writer 3 upon clicking the icon for writing data.

On the other hand, upon clicking the icon for reading data under the condition that the reader-writer 3 is placed in the range within which communication with the IC tag 2 is effectively done, the reader-writer 3 reads data from the IC tag 2 and the data optimizing means operates to perform data optimizing operation (data decompression and reintegration operations), whereby the image data is associated with the image display position 31 of the browser and displayed, and the text data such as construction-related data are displayed at the text data display position. Note that the constitution and the operating means of the data processing unit 10 are not limited to the ones as described above.

The construction image data recording system according to the present invention can input photographic data with a great capacity to an IC tag at the construction site and can also read the inputted data from the IC tag at the verification site to restore the read data to the original photograph and display the restored photograph.

1. A construction image data recording system characterized by comprising an IC tag to be embedded in a structure, a reader-writer for writing construction image data to and reading the construction image data from said IC tag, a data processing unit for optimizing the capacity of the construction image data so as to be written to said IC tag and restoring the construction image data read by the said reader-writer, a display unit for displaying said construction image data and a photographing unit for inputting image data to said data processing unit.

2. A construction image data recording system according to claim 1 characterized in that said data processing unit includes a data optimizing means for performing data compression processing so that the capacity of data be acceptable to the capacity of a non-volatile memory provided to said IC tag, the compressed image data compressed by the data optimizing means is written from the reader-writer to said IC tag, and the data read from said IC tag by means of the reader-writer is restored by means of the data optimizing means, whereby the data is displayed on said display unit.

3. A construction image data recording system according to claim 1 characterized in that said data processing unit includes a data optimizing means for dividing data to a plurality of data so that the divided data can be stored in a non-volatile memory with a given capacity provided to said IC tag, writes a plurality of image data divided by said data optimizing means to a plurality of IC tags together with the associated connecting information, and reintegrates the divided data read by the reader-writer from said plurality of IC tags to the original image based on said connecting information by means of said data optimizing means to thereby display the reintegrated image data on said display unit.

4. A construction image data recording system according to claim 1 characterized in that said data processing unit includes a data optimizing means for compressing the capacity of data and dividing the data to a plurality of data so that each capacity of the divided data be acceptable to the capacity of a non-volatile memory provided to said IC tag, respectively, writes the image data compressed and divided by said data optimizing means to said plurality of IC tags together with the respective associated connecting information, and restore a plurality of compressed and divided image data read from said plurality of IC tags by the reader-writer to the original image data based on said associated connecting information by means of the data optimizing means to thereby display the restored image data on said display unit.

5. A data recording unit adapted to be embedded in a structure characterized in that an IC tag is embedded in a concrete block and said concrete block is embedded in a desired location in the structure.

6. A data recording unit adapted to be embedded in a structure according to claim 5 characterized in that said IC is directed in a prescribed direction relative to the concrete block and is embedded in the concrete block.

7. A data recording unit adapted to be embedded in a structure according to claim 5 characterized in that said plurality of IC tags are embedded in said concrete block at a distance with which no interference to writing and reading data to/from said IC tags is caused by the neighboring IC tags.

8. A data recording unit adapted to be embedded in a structure according to claim 5 characterized in that the image data subjected to the data compression processing is written to said IC tag.

9. A data recording unit adapted to be embedded in a structure according to claim 5 characterized in that the divide image data are written to said plurality of IC tags together with the associated connecting information.

10. A data recording unit adapted to be embedded in a structure according to claim 5 characterized in that the image data subjected to the data division processing in addition to the data compression processing is written to said plurality of IC tags together with the associated connecting information.

11. A data recording unit adapted to be embedded in a structure according to claim 5 characterized in that said structure is a structure made of concrete.

12. A data recording unit adapted to be embedded in a structure according to claim 6 characterized in that said plurality of IC tags are embedded in said concrete block at a distance with which no interference to writing and reading data to/from said IC tags is caused by the neighboring IC tags.

13. A data recording unit adapted to be embedded in a structure according to claim 6 characterized in that the image data subjected to the data compression processing is written to said IC tag.

14. A data recording unit adapted to be embedded in a structure according to claim 7 characterized in that the image data subjected to the data compression processing is written to said IC tag.

15. A data recording unit adapted to be embedded in a structure according to claim 12 characterized in that the image data subjected to the data compression processing is written to said IC tag.

16. A data recording unit adapted to be embedded in a structure according to claim 6 characterized in that the divide image data are written to said plurality of IC tags together with the associated connecting information.

17. A data recording unit adapted to be embedded in a structure according to claim 7 characterized in that the divide image data are written to said plurality of IC tags together with the associated connecting information.

18. A data recording unit adapted to be embedded in a structure according to claim 8 characterized in that the divide image data are written to said plurality of IC tags together with the associated connecting information.

19. A data recording unit adapted to be embedded in a structure according to claim 12 characterized in that the divide image data are written to said plurality of IC tags together with the associated connecting information.

20. A data recording unit adapted to be embedded in a structure according to claim 13 characterized in that the divide image data are written to said plurality of IC tags together with the associated connecting information.
